(19) United States
(12) Patent Application Publication
(10) Pub. No.: US 2026/0140829 A1
(43) Pub. Date: May 21, 2026

(54) CHECKING BACKUP DATA BASED ON HONEYPOT OBJECTS

(71) Applicant: HEWLETT PACKARD ENTERPRISE DEVELOPMENT LP, Spring, TX (US)

(72) Inventors: Jonathan Taragin, Herzliya (IL); Omer Uretzky, Herzliya (IL)

(21) Appl. No.: 18/951,758

(22) Filed: Nov. 19, 2024

(51) Int. Cl. G06F 11/14

(52) U.S. Cl. CPC G06F 11/1458; G06F 2201/805

(57) ABSTRACT

In some examples, a system receives a representation of a honeypot pattern and information of a honeypot object containing the honeypot pattern injected into primary data. The system checks backup data created by a backup management system by identifying an instance of the honeypot object in the backup data, and determining whether data of the instance of the honeypot object deviates from the honeypot pattern. Based on determining that the data of the instance of the honeypot object deviates from the honeypot pattern, the system triggers a remediation action relating to the backup data.

### BACKGROUND

A malware attack can seek to corrupt data in a computing environment. An example of a malware attack is a ransomware attack that encrypts data. In a ransomware attack, data can be encrypted using an encryption key, which renders the data inaccessible to users unless a ransom is paid to obtain the encryption key. A malware attack that corrupts data can be highly disruptive to enterprises, including businesses, government agencies, educational organizations, individuals, and so forth.

### BRIEF DESCRIPTION OF THE DRAWINGS

Some implementations of the present disclosure are described with respect to the following figures.

FIG. 1 is a block diagram of an arrangement including a computing environment and a backup environment, according to some examples.

FIG. 2 is a flow diagram of a validation process according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A malware attack that seeks to corrupt data can target both primary data and backup data. Primary data is the data used during operations of a computing system. Backup data is produced by replicating the primary data to a backup storage system. An example of a malware attack is a ransomware attack. If the ransomware attack is successful in encrypting both the primary data and the backup data, then a user would not be able to restore the user's data using the backup data.

A challenge associated with protection against malware attacks is the dwell time of the malware, which is the time period between when the malware has infected a system and when the system detects the malware. During the dwell time, a backup management system can create backups of data, which can include corrupted data that has been corrupted by the malware. As a result, backup data stored in the backup storage system may contain the corrupted data, which can prevent a successful recovery of primary data. A further challenge is that the backup management system itself may be corrupted. For example, the backup management system may may be infected by a virus or another type of malware, which can corrupt the way the backup management system creates backup data. Instead of creating clean backup data, the infected backup management system may store corrupted backup data in a backup storage system.

In accordance with some implementations of the present disclosure, a backup protection system includes a protection agent that adds a honeypot object containing a honeypot pattern to primary data. A representation of the honeypot pattern and information of the honeypot object can be sent by the protection agent to a validation agent that is also part of the backup protection system. The representation of the honeypot pattern may be sent to the validation agent in response to the protection agent adding the honeypot object (or multiple copies of the honeypot object) to the primary data. In examples where honeypot objects with respective different honeypot patterns are added to the primary data, the protection agent can send the representations of the different honeypot patterns to the validation agent as the different honeypot objects are added to the primary data. For example, if a honeypot pattern changes and a new honeypot object with the changed honeypot pattern is added to the primary data, the protection agent can send the representation of the changed honeypot pattern to the validation agent. The validation agent checks backup data for corruption prior to committing the backup data to a backup storage system. The checking performed by the validation agent includes identifying an instance of the honeypot object in the backup data, and determining whether data of the instance of the honeypot object deviates from the honeypot pattern. Based on determining that the data of the instance of the honeypot object deviates from the honeypot pattern, the validation agent triggers a remediation action relating to the backup data.

In some examples, the backup storage system stores immutable backup data that is not intended to be changed after the backup data has been committed to the backup storage system. This type of backup storage system can be referred to as a data vault or long-term backup storage system. In some cases, immutability of the backup data can be achieved by creating an airgap between the backup storage system and a computing environment. The airgap can be achieved by physically disconnecting the backup storage system from the computing environment after the backup data has been written to the backup storage system. Other techniques for isolating a data vault from a computing environment can be used in further examples.

In other examples, techniques or mechanisms according to some implementations of the present disclosure can be applied to other types of backup storage systems, including backup storage systems that remain connected to a computing environment and are updated with new backup data relatively frequently.

An "object" can refer to a file, a data chunk, or any other container of data. A "honeypot pattern" can refer to any specified pattern of information that is to be contained in a honeypot object. For example, the honeypot pattern may include random data, data that looks like passwords or other sensitive information that an attacker may target, or any other defined data that is not intended to be modified by production operations in a computing environment. "Production operations" refer to operations of programs or electronic devices during normal use of the programs or electronic devices.

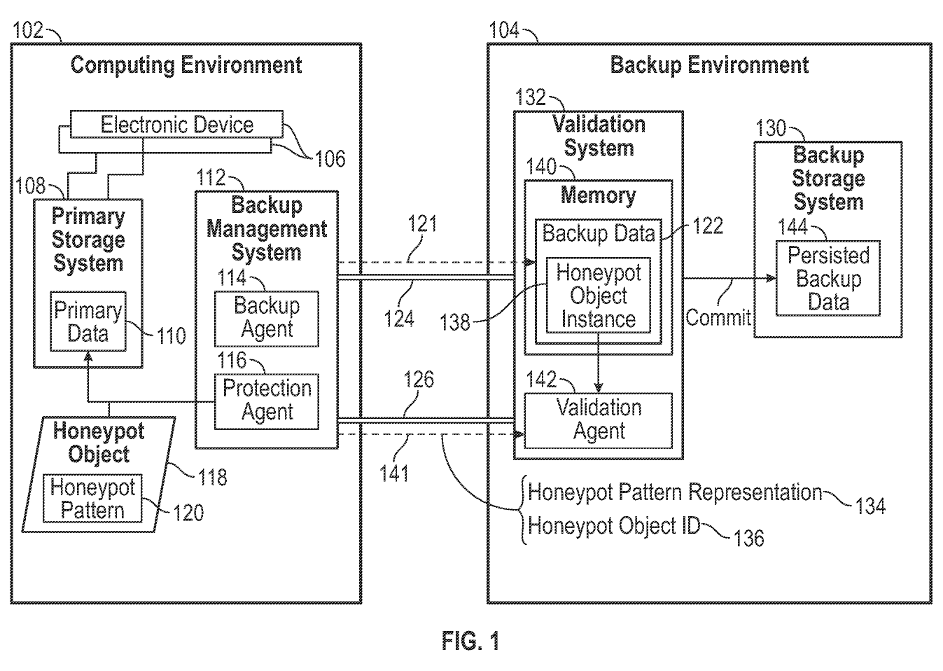

FIG. 1 is a block diagram of an example arrangement including a computing environment 102 and a backup environment 104. The computing environment 102 can include a data center, a cloud computing environment, a server computing environment, or any other type of computing environment.

The computing environment 102 can include various electronic devices 106 that can execute programs to perform various operations. The operations can include reading and writing of data. The data can be stored in a primary storage system 108, which can be implemented using one or more storage devices. The primary storage system 108 stores primary data 110 that is accessible to the electronic devices 106. Although just one primary storage system is shown in FIG. 1, there may be multiple primary storage systems in other examples.

The backup environment 104 may be remotely located from the computing environment 102. For example, the computing environment 102 and the backup environment 104 may be located in different cities, different states or provinces, different countries, or other different geographic locations. More generally, the backup environment 104 is at a first physical location distinct from a second physical location of the computing environment 102. In other examples, the backup environment 104 and the computing environment 102 may be in the same physical location, such as in the same facility of an enterprise (e.g., a business, an educational organization, a government agency, an individual, etc.).

The computing environment 102 also includes a backup management system 112 that manages the backup of the primary data 110 in the primary storage system 108 (as well as primary data in any other primary storage system of the computing environment 102) to the backup environment 104. In other examples, the backup management system 112 can be part of the backup environment 104.

The backup management system 112 includes a backup agent 114 and a protection agent 116. The backup agent 114 schedules the creation of backup data to be stored in a backup storage system 130 of the backup environment 104. The backup management system 112 can create backup data on a periodic basis (e.g., once every specified time interval). The backup management system 112 can also create backup data in response to other events, such as a user request, an event triggered by an operation in the computing environment 102, or any other event.

The protection agent 116 inserts a honeypot object 118 into the primary data 110 stored in the primary storage system 108. In an example where the primary data 110 includes files of a file system, the honeypot object 118 includes a honeypot file. Although FIG. 1 shows the protection agent 116 injecting just one honeypot object 118 into the primary data 110, in other examples, the protection agent 116 can inject multiple honeypot objects into the primary data 110. Injecting a honeypot object can refer to adding the honeypot object to a specific part of the primary data 110. In examples where the primary data 110 includes files of a file system, the protection agent 116 can inject multiple honeypot files into different directories of the file system.

The honeypot object 118 that is injected into the primary data 110 includes a honeypot pattern 120. In examples where multiple honeypot objects are injected into the primary data 110, at least some of the honeypot objects may include different honeypot patterns. For example, a first honeypot object added to a first part of the primary data 110 (e.g., a first directory of a file system) includes a first honeypot pattern, and a second honeypot object added to a second part of the primary data 110 (e.g., a second directory of the file system) includes a second honeypot pattern different from the first honeypot pattern.

An instance of the honeypot object 118 added to the primary data 110 would appear in backup data created by the backup agent 114. The backup agent 114 sends (at 121) backup data 122 over a backup communication channel 124 to the backup environment 104. An instance of the honeypot object 118 (referred to as a "honeypot object instance" 138) is present in the backup data 122 stored in a memory 140 of a validation system 132 in the backup environment 104. The honeypot object instance 138 can be a copy of the honeypot object 118. In other examples, the validation system 132 can be part of the computing environment 102.

In addition to the backup communication channel 124, a secondary communication channel 126 exists between the backup management system 112 and the backup environment 104. The secondary communication channel 126 is an out-of-band communication channel that is distinct and separate from the backup communication channel 124 used to transfer backup data from the computing environment 102 to the backup environment 104. The secondary communication channel 126 can be a secured communication channel protected against unauthorized access. For example, the secured communication channel can be protected by encrypting information transferred over the secured communication channel. Alternatively, the secured communication channel can be protected by authenticating entities communicating with one another over the secured communication channel.

In some examples, the protection agent 116 can send (at 141) the following information over the secondary communication channel 126 to a validation agent 142 in the validation system 132: (1) a honeypot pattern representation 134 that represents the honeypot pattern 120, and (2) honeypot object identifier 136 that identifies the honeypot object 118. In some examples, the honeypot pattern representation 134 can include a hash value derived by applying a hash function (e.g., a cryptographic hash function) on the honeypot pattern 120. The hash value can be much smaller in size than the honeypot pattern 120 contained in the honeypot object 118. As a result, communicating the hash value over the secondary communication channel 126 consumes less communication bandwidth as compared to communicating the honeypot pattern 120. In other examples, a different type of function can be applied on the honeypot pattern 120 to produce the honeypot pattern representation 134. In further examples, the honeypot pattern representation 134 can be the honeypot pattern 120 itself.

The honeypot object identifier 136 can include identification information useable to identify the honeypot object 118. If the honeypot object 118 is a honeypot file in a file system, then the honeypot object identifier 136 can include a pathname that includes a file name and one or more directories that the honeypot file is part of. In other examples, the honeypot object identifier 136 can include a different identifier of the honeypot object 118, such as a uniform resource identifier (URI) or any other type of object identifier.

The validation agent 142 uses the honeypot object identifier 136 to find the honeypot object instance 138 in the backup data 122). For example, if the honeypot object identifier 136 is a pathname of a honeypot file, then the validation agent 142 can use the pathname to find an instance of the honeypot file in the backup data 122.

In examples where the protection agent 116 injected multiple honeypot objects into the primary data 110, the protection agent 116 can send multiple honeypot pattern representations and honeypot object identifiers corresponding to the multiple honeypot objects to the validation agent 142.

In some examples, the protection agent 116 may update honeypot objects and/or honeypot patterns. Updating a honeypot object can refer to inserting a new honeypot object into the primary data 110, either to add the honeypot object or to replace a previously injected honeypot object. Updating a honeypot pattern refers to changing the honeypot pattern so that any newly created honeypot object contains the changed honeypot pattern. Updating honeypot objects and/or honeypot patterns allows the honeypot objects to be less predictable for an attacker. Also, an attacker may find more frequently updated data, including honeypot objects, to be more appealing to attack. When a honeypot object and/or a honeypot pattern is updated, the protection agent 116 sends information pertaining to the changed honeypot object and/or honeypot pattern to the validation agent 142.

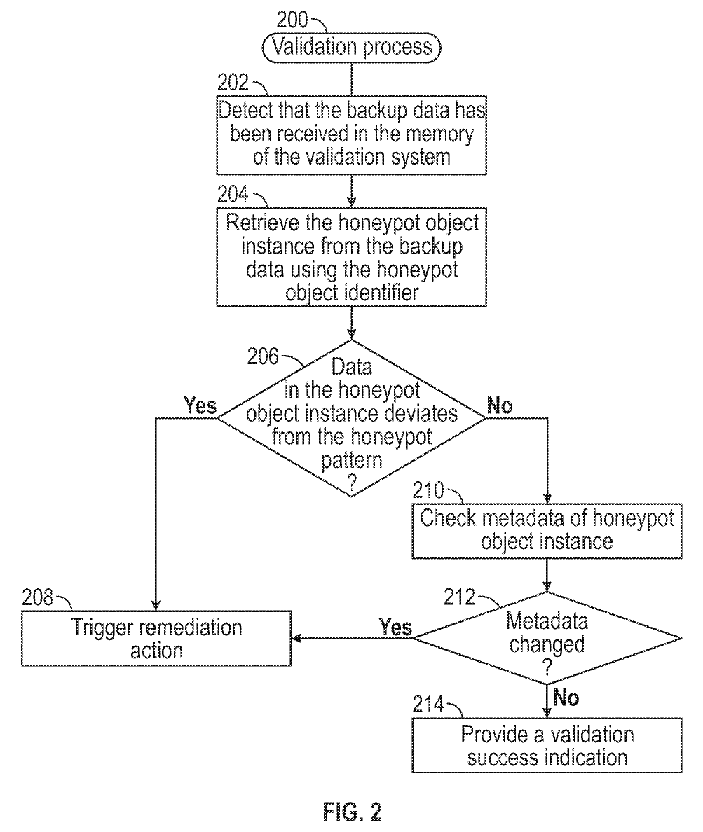

The following refers to both FIG. 1 and FIG. 2. FIG. 2 is a flow diagram of a validation process 200 performed by the validation agent 142. The validation agent 142 validates the backup data 122 before committing the backup data 122 to the backup storage system 130. FIG. 2 shows a sequence of tasks. In other examples, the tasks can be performed in a different order, some tasks may be omitted, or other tasks may be added.

The validation agent 142 detects (at 202) that the backup data 122 has been received in the memory 140 of the validation system 132. For example, the validation agent 142 may poll the memory 140 (or a specific memory location of the memory 140) to detect when new backup data has been added. Alternatively, a program in the validation system 132 can issue an alert to the validation agent 142 when new backup data has been added to the memory 140.

The validation agent 142 retrieves (at 204) the honeypot object instance 138 from the backup data 122 using the honeypot object identifier 136. The validation agent 142 checks the backup data 122 by determining (at 206) whether data in the honeypot object instance 138 deviates from the honeypot pattern 120. In examples where the honeypot pattern representation 134 is a hash value, the validation agent 142 can apply the hash function on the data of the honeypot object instance 138 to derive a computed hash value. The validation agent 142 compares the computed hash value to the hash value of the honeypot pattern representation 134 received from the protection agent 116. If the hash values match, then that indicates that the honeypot object instance 138 has not been tampered with. However, if the hash values do not match, then that indicates that the honeypot object 118 has been modified.

In other examples, if a different function is used to compute the honeypot pattern representation 134, the validation agent 142 computes a value by applying the different function to the data of the honeypot object instance 138. The validation agent 142 compares the computed value to the value in the honeypot pattern representation 134. If the computed value does not match the value in the honeypot pattern representation 134, that indicates the honeypot object instance 138 has been tampered with. In further examples where the honeypot pattern representation 134 includes the honeypot pattern 120 itself, the validation agent 142 compares the data in the honeypot object instance 138 to the honeypot pattern 120. If the data in the honeypot object instance 138 does not match the honeypot pattern 120, that indicates the honeypot object instance 138 has been tampered with.

In response to determining (at 206) that the data of the honeypot object instance 138 deviates from the honeypot pattern 120, the validation agent 142 can trigger (at 208) a remediation action. The remediation action can include any one or more of the following: issue an alert to a target entity, such as a system administrator, a program, or a machine; block the commitment of the backup data 122 to the backup storage system 130; or any other remediation action.

On the other hand, if the validation agent 142 determines (at 206) that the data of the honeypot object instance 138 does not deviate from the honeypot pattern 120, the validation agent 142 can perform further checking of the backup data by checking (at 210) metadata of the honeypot object instance 138. A change in the metadata can indicate tampering with the honeypot object instance 138.

The metadata can include one or more properties of the honeypot object instance 138. For example, properties can include a creation date of the honeypot object 118, a last modified date of the honeypot object 118, a last accessed data of the honeypot object 118, an owner of the honeypot object 118, permissions (e.g., read and write permissions) of the honeypot object 118, or other attributes. Further examples of metadata include a name of the honeypot object 118, an extension (e.g., .DOCX extension, .PDF extension, etc.) of the honeypot object 118, a size of the honeypot object 118, or a type of the honeypot object 118. Additional properties can include a title of the honeypot object 118, an author of the honeypot object 118, a description of the honeypot object 118, and so forth.

The validation agent 142 determines (at 212) whether the metadata of the honeypot object instance 138 has changed. If the validation agent 142 detects a change of any or some combination of the foregoing properties, the validation agent 142 can trigger (at 208) the remediation action. However, if the metadata of the honeypot object instance 138 has not changed, the validation agent 142 provides (at 214) a validation success indication. The validation success indication causes the validation system 132 to commit the backup data 122 to the backup storage system 130 as persisted backup data 144.

In examples where the primary data 110 includes multiple honeypot objects possibly with different honeypot patterns, the validation agent 142 can determine whether the data of any of multiple honeypot object instances deviate from respective honeypot patterns. If any deviation is detected, the validation agent 142 can trigger the remediation action.

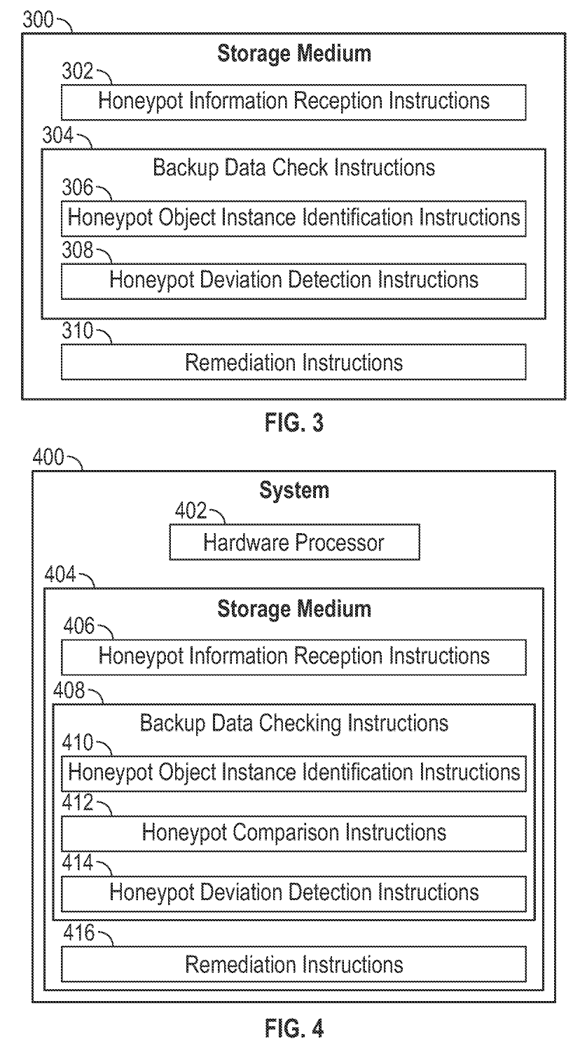

FIG. 3 is a block diagram of a non-transitory machine-readable or computer-readable storage medium 300 storing machine-readable instructions that upon execution cause a system to perform various tasks. The system can include the validation system 132, for example.

The machine-readable instructions include honeypot information reception instructions 302 to receive a representation of a honeypot pattern and information of a honeypot object containing the honeypot pattern injected into primary data. The representation of a honeypot pattern can include a value derived by applying a function (e.g., a hash function0 on the honeypot pattern. The information of the honeypot object can include a honeypot object identifier.

The machine-readable instructions include backup data check instructions 304 to check backup data created by a backup management system (e.g., 112 in FIG. 1). The backup data check instructions 304 include honeypot object instance identification instructions 306 to identify an instance of the honeypot object in the backup data. The identification of the instance of the honeypot object in the backup data can be based on an identifier of the honeypot object, for example.

The backup data check instructions 304 include honeypot deviation detection instructions 308 to determine whether data of the instance of the honeypot object deviates from the honeypot pattern. The determination can be include comparing a value based on data of the instance of the honeypot object to the representation of the honeypot pattern.

The machine-readable instructions include remediation instructions 310 to, based on determining that the data of the instance of the honeypot object deviates from the honeypot pattern, trigger a remediation action relating to the backup data. The remediation action may include blocking a commit of the backup data to a backup storage system.

In some examples, the representation of the honeypot pattern includes a value computed by applying a function on the honeypot pattern. The machine-readable instructions can compute a value based on the data of the instance of the honeypot object, and compare the computed value to the value in the representation of the honeypot pattern. The determining of whether the data of the instance of the honeypot object deviates from the honeypot pattern is based on the comparing.

In some examples, the representation of the honeypot pattern and the information of the honeypot object are received at the system from a protection agent over a secondary communication channel that is separate from a backup communication channel over which the backup data is transferred to a backup storage system.

In some examples, the honeypot pattern is a first honeypot pattern, and the honeypot object is a first honeypot object. The machine-readable instructions can receive a representation of a second honeypot pattern and information of a second honeypot object containing the second honeypot pattern injected into the primary data. The checking of the backup data further includes identifying an instance of the second honeypot object in the backup data, and determining whether data of the instance of the second honeypot object deviates from the second honeypot pattern.

In some examples, the first honeypot object includes a first honeypot file in a first directory of a file system, and the second honeypot object includes a second honeypot file in a second directory of the file system.

In some examples, the checking of the backup data further includes determining whether metadata of the instance of the honeypot object has changed. The machine-readable instructions can trigger the remediation action based on determining that the metadata of the instance of the honeypot object has changed.

FIG. 4 is a block diagram of a system 400 according to some examples. The system 400 may be an example of the validation system 132 of FIG. 1. The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include honeypot information reception instructions 406 to receive a representation of a honeypot pattern and information of a honeypot object containing the honeypot pattern injected into primary data. The primary data may be stored in a primary storage system.

The machine-readable instructions in the storage medium 404 include backup data checking instructions 408 to check backup data created by a backup management system. The backup data checking instructions 408 include honeypot object instance identification instructions 410 to identify an instance of the honeypot object in the backup data.

The backup data checking instructions 408 include honeypot comparison instructions 412 to compare a value based on data of the instance of the honeypot object to the representation of the honeypot pattern. The value can be a hash value or any other value derived by applying a function on the data of the instance of the honeypot object.

The backup data checking instructions 408 include honeypot deviation detection instructions 414 to determine, based on the comparing, whether data of the instance of the honeypot object deviates from the honeypot pattern.

The machine-readable instructions in the storage medium 404 include remediation instructions 416 to, based on determining that the data of the instance of the honeypot object deviates from the honeypot pattern, trigger a remediation action relating to the backup data.

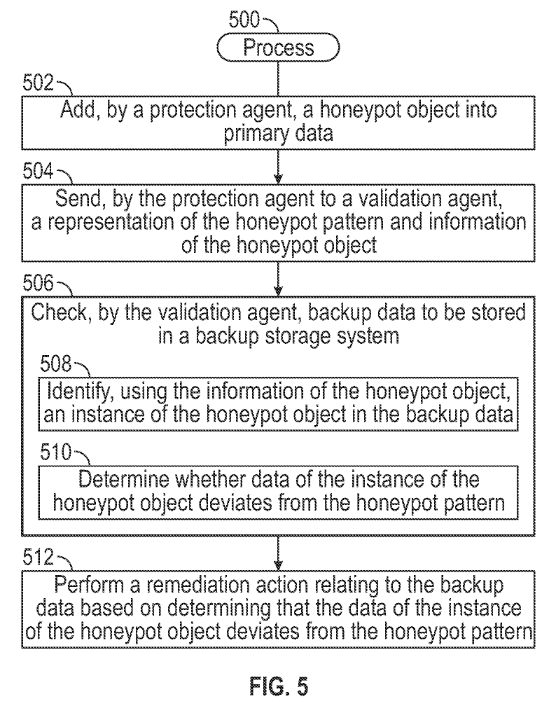

FIG. 5 is a flow diagram of a process 500 according to some examples. The process 500 may be performed by a backup protection system including the protection agent 116 and validation agent 142 of FIG. 1, for example.

The process 500 includes adding (at 502), by a protection agent, a honeypot object into primary data. The honeypot object may be a honeypot file added to a directory of a file system. The honeypot object includes a honeypot pattern.

The process 500 includes sending (at 504), by the protection agent to a validation agent, a representation of the honeypot pattern and information of the honeypot object. The information of the honeypot object can include an identifier of the honeypot object.

The process 500 includes checking (at 506), by the validation agent, backup data to be stored in a backup storage system. The checking includes identifying (at 508), using the information of the honeypot object, an instance of the honeypot object in the backup data. The checking also includes determining (at 510) whether data of the instance of the honeypot object deviates from the honeypot pattern.

The process 500 includes performing (at 512) a remediation action relating to the backup data based on determining that the data of the instance of the honeypot object deviates from the honeypot pattern.

Each of the backup management system 112 and the validation system 132 of FIG. 1 can be implemented using one or more computers. In further examples, the backup management system 112 and the validation system 132 can be integrated into one system.

An "electronic device" can refer to a desktop computer, a notebook computer, a tablet computer, a smartphone, a server computer, a storage system, a communication node, or any other type of electronic device.

An "agent" can be implemented with machine-readable instructions executed by a processing resource of a system. A "storage device" can refer to a disk-based storage device, a solid state drive, or another type of storage device. A "memory" can be implemented with one or more memory devices, such as a dynamic random access memory (DRAM) device, a static random access memory (SRAM) device, an erasable and programmable read-only memory (EPROM) device, an electrically erasable and programmable read-only memory (EEPROM) device, or a flash memory device.

A storage medium (e.g., 300 in FIG. 3 or 404 in FIG. 4) can include any or some combination of the following: a semiconductor memory device such as DRAM or SRAM, an EPROM, an EEPROM, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive a representation of a honeypot pattern and information of a honeypot object containing the honeypot pattern injected into primary data;
check backup data created by a backup management system, the checking comprising:
identifying an instance of the honeypot object in the backup data, and
determining whether data of the instance of the honeypot object deviates from the honeypot pattern; and
based on determining that the data of the instance of the honeypot object deviates from the honeypot pattern, trigger a remediation action relating to the backup data.

2. The non-transitory machine-readable storage medium of claim 1, wherein the determining of whether the data of the instance of the honeypot object deviates from the honeypot pattern comprises comparing a value derived from the data of the instance of the honeypot object to the representation of the honeypot pattern.

3. The non-transitory machine-readable storage medium of claim 2, wherein the representation of the honeypot pattern comprises a value computed by applying a function on the honeypot pattern, and wherein the instructions upon execution cause the system to:
compute a value based on the data of the instance of the honeypot object; and
compare the computed value to the value in the representation of the honeypot pattern,
wherein the determining of whether the data of the instance of the honeypot object deviates from the honeypot pattern is based on the comparing.

4. The non-transitory machine-readable storage medium of claim 1, wherein the representation of the honeypot pattern and the information of the honeypot object are received at the system from a protection agent over a secondary communication channel that is separate from a backup communication channel over which the backup data is transferred to a backup storage system.

5. The non-transitory machine-readable storage medium of claim 4, wherein the system is separate from a computing environment at which the protection agent executes and including a primary storage system that stores the primary data.

6. The non-transitory machine-readable storage medium of claim 4, wherein the honeypot object is injected by the protection agent into the primary data.

7. The non-transitory machine-readable storage medium of claim 1, wherein the honeypot pattern is a first honeypot pattern, the honeypot object is a first honeypot object, and the instructions upon execution cause the system to:
receive a representation of a second honeypot pattern and information of a second honeypot object containing the second honeypot pattern injected into the primary data,
wherein the checking comprises:
identifying an instance of the second honeypot object in the backup data, and
determining whether data of the instance of the second honeypot object deviates from the second honeypot pattern.

8. The non-transitory machine-readable storage medium of claim 7, wherein the first honeypot object comprises a first honeypot file in a first directory of a file system, and the second honeypot object comprises a second honeypot file in a second directory of the file system.

9. The non-transitory machine-readable storage medium of claim 1, wherein the remediation action comprises blocking a commit of the backup data to a backup storage system.

10. The non-transitory machine-readable storage medium of claim 1, wherein the information of the honeypot object comprises an identifier of the honeypot object, and the identifying of the instance of the honeypot object in the backup data is based on the identifier of the honeypot object.

11. The non-transitory machine-readable storage medium of claim 1, wherein the checking further comprises determining whether metadata of the instance of the honeypot object has changed, and wherein the instructions upon execution cause the system to:
trigger the remediation action based on determining that the metadata of the instance of the honeypot object has changed.

12. A method comprising:
adding, by a protection agent, a honeypot object into primary data;
sending, by the protection agent to a validation agent, a representation of a honeypot pattern and information of the honeypot object;
checking, by the validation agent executed in a validation system comprising a hardware processor, backup data to be stored in a backup storage system, the checking comprising:
identifying, using the information of the honeypot object, an instance of the honeypot object in the backup data, and
determining whether data of the instance of the honeypot object deviates from the honeypot pattern; and
based on determining that the data of the instance of the honeypot object deviates from the honeypot pattern, performing a remediation action relating to the backup data.

13. The method of claim 12, wherein the protection agent is executed in a first system comprising a primary storage system storing the primary data, the first system being separate from the validation system.

14. The method of claim 12, wherein the information of the honeypot object sent by the protection agent to the validation agent comprises an identifier of the honeypot object.

15. The method of claim 12, wherein the honeypot object is a first honeypot object, and the honeypot pattern is a first honeypot pattern, the method further comprising:
adding, by the protection agent, a representation of a second honeypot object into the primary data;
sending, by the protection agent to the validation agent, a second honeypot pattern and information of the second honeypot object,
wherein the checking comprises:
identifying an instance of the second honeypot object in the backup data, and
determining whether data of the instance of the second honeypot object deviates from the second honeypot pattern.

16. The method of claim 15, wherein the second honeypot pattern is different from the first honeypot pattern.

17. A system comprising:
a hardware processor; and
a non-transitory storage medium storing instructions executable on the hardware processor to:
receive a representation of a honeypot pattern and information of a honeypot object containing the honeypot pattern injected into primary data;
check backup data created by a backup management system, the checking comprising:
identifying an instance of the honeypot object in the backup data,
compare a value based on data of the instance of the honeypot object to the representation of the honeypot pattern,
determining, based on the comparing, whether data of the instance of the honeypot object deviates from the honeypot pattern; and
based on determining that the data of the instance of the honeypot object deviates from the honeypot pattern, trigger a remediation action relating to the backup data.

18. The system of claim 17, wherein the representation of the honeypot pattern comprises a hash value derived by applying a hash function on the honeypot pattern, and wherein the value compared to the representation of the honeypot pattern is computed by the instructions by applying the hash function on the data of the instance of the honeypot object.

19. The system of claim 17, wherein the honeypot object is a honeypot file added to a directory of a file system containing the primary data, and wherein the information of the honeypot object comprises a pathname of the honeypot file in the file system.

20. The system of claim 17, wherein the remediation action comprises blocking a commit of the backup data to a backup storage system.
